(19) United States
(12) Patent Application Publication
(10) Pub. No.: US 2025/0166327 A1
(43) Pub. Date: May 22, 2025

(54) CONTENT GENERATION SYSTEM AND METHOD

(71) Applicant: Sony Interactive Entertainment Inc., Tokyo (JP)

(72) Inventor: Guy Moss, London (GB)

(21) Appl. No.: 18/948,151

(22) Filed: Nov. 14, 2024

(30) Foreign Application Priority Data
Nov. 22, 2023 (GB) 2317867.6

(51) Int. Cl. G06T 19/20

(52) U.S. Cl. CPC G06T 19/20; G06T 2219/2004; G06T 2219/2016

(57) ABSTRACT

A content generation system, comprising: receiving circuitry configured to receive environment geometry data of at least part of a three-dimensional, 3D, virtual environment; selecting circuitry comprising a selecting model trained to select, based on the received environment geometry data, one or more virtual elements; and generating circuitry configured to instantiate the selected virtual elements within the at least part of the virtual environment.

### FIELD OF INVENTION

The present invention relates to a content generation system and method.

### BACKGROUND

In recent years, the virtual environments of video games and animated films have become increasingly more expansive and complex with greater numbers of virtual elements (characters, objects, buildings, scenery, and the like) being disposed therein, and more complex rendering processes (ray-tracing, for example) being performed thereon. This increase in complexity aims to provide a more immersive gaming experience for users.

However, this increase in complexity typically places a greater creative burden on video game and/or film developers, who have to spend increasingly greater amounts of time creating bespoke virtual elements and/or selecting pre-made virtual elements (from an asset library, for example) that are appropriate for the virtual environment of the video game/film they are developing.

The present invention seeks to alleviate or mitigate this issue.

### SUMMARY OF THE INVENTION

In a first aspect, a content generation system is provided in claim 1.

In another aspect, a content generation method is provided in claim 13.

Further respective aspects and features of the invention are defined in the appended claims.

Embodiments of the present invention will now be described by way of example with reference to the accompanying drawings, in which:

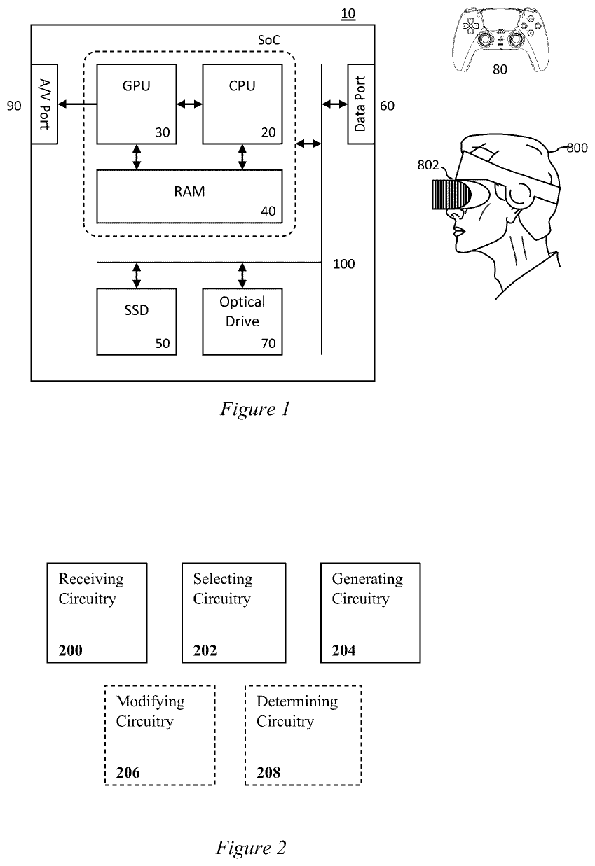

FIG. 1 schematically illustrates an entertainment system operable as a content generation system according to embodiments of the present description;

FIG. 2 schematically illustrates a content generation system according to embodiments of the present description;

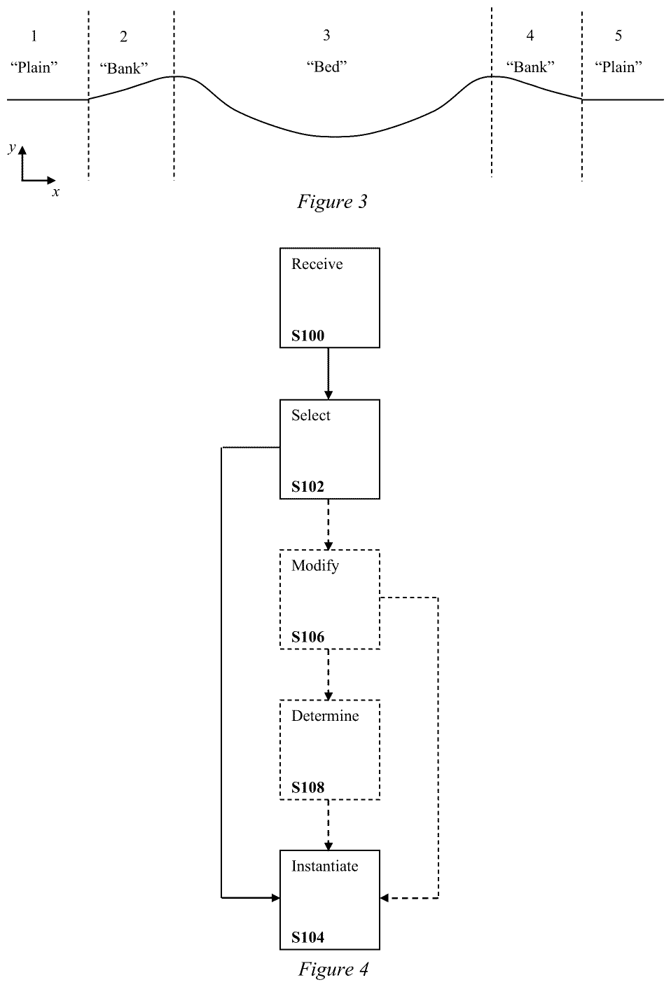

FIG. 3 schematically illustrates the association of geographical/environment features with the geometric/topological features of a 3D virtual environment.

FIG. 4 schematically illustrates a content generation method according to embodiments of the present description.

### DESCRIPTION OF THE EMBODIMENTS

A content generation system and method are disclosed. In the following description, a number of specific details are presented in order to provide a thorough understanding of the embodiments of the present invention. It will be apparent, however, to a person skilled in the art that these specific details need not be employed to practice the present invention. Conversely, specific details known to the person skilled in the art are omitted for the purposes of clarity where appropriate.

In an example embodiment of the present description, an entertainment system may be operable as a content generation system.

Referring to FIG. 1, an example of an entertainment system 10 is a computer or console.

The entertainment system 10 comprises a central processor or CPU 20. The entertainment system also comprises a graphical processing unit or GPU 30, and RAM 40. Two or more of the CPU, GPU, and RAM may be integrated as a system on a chip (SoC).

Further storage may be provided by a disk 50, either as an external or internal hard drive, or as an external solid-state drive, or an internal solid-state drive.

The entertainment device may transmit or receive data via one or more data ports 60, such as a USB port, Ethernet® port, Wi-Fi® port, Bluetooth® port or similar, as appropriate. It may also optionally receive data via an optical drive 70.

Audio/visual outputs from the entertainment device are typically provided through one or more A/V ports 90 or one or more of the data ports 60.

Where components are not integrated, they may be connected as appropriate either by a dedicated data link or via a bus 100.

An example of a device for displaying images output by the entertainment system is a head mounted display ‘HMD’ 802, worn by a user 800.

As mentioned previously, the increasing complexity of video game/animated film environments (that is, virtual environments) typically results in increasingly greater amount of time spent developing the video games because a greater creative burden is placed on video game/film developers.

These issues may be mitigated or alleviated by implementing means for automatically selecting virtual elements (characters, objects, buildings, scenery, textures, and the like) for a virtual (video game) environment based on the surface geometry of that virtual environment, which may be defined in mesh data, point cloud data, or the like. Such automatic selection may optionally be based on user prompts such as text prompts, voice prompts, and the like.

Optionally, such means may also determine the locations and/or orientations in which the selected virtual elements are to be disposed (instantiated) within the virtual environment, and/or modify the shape, size, colour, and the like, of the selected virtual elements.

### Content Generation System

Accordingly, turning now to FIG. 2, in embodiments of the present description, a content generation system comprises receiving circuitry 200 configured to receive environment geometry data of at least part of a three-dimensional, 3D, virtual environment; selecting circuitry 202 comprising a selecting model trained to select, based on the received environment geometry data, one or more virtual elements; and generating circuitry 204 configured to instantiate the selected virtual elements within the at least part of the virtual environment.

As a non-limiting example of the content generation system in operation, consider a game developer creating a 3D virtual environment of a video game to be released.

The game developer may possess environment geometry data (a mesh, point cloud, or the like) that defines the surface geometry of at least a part of the 3D virtual environment in question. As a non-limiting example, this part of the 3D virtual environment may represent a wide river estuary surrounded by flat land or plains, and the developer may wish to populate this part of the 3D virtual environment with virtual elements such as skyscrapers, urban infrastructure, road and rail networks, parks, stadiums, and the like, and thereby create a large city within this part of the 3D virtual environment.

Heretofore, the developer would have to manually create and/or select these virtual elements and subsequently place (instantiate) them within this part of the 3D virtual environment at a desired location and with a desired orientation. As will be appreciated by persons skilled in the art, carrying out this process in order to create the large city places a large creative burden on the developer, and thereby increases the amount of time taken to develop the game.

Therefore, the developer may instead provide the environment geometry data of the river estuary and plains to the content generation system via receiving circuitry 200 (a data port 60, for example). Subsequently, the selecting model comprised within (that is, being executed by) selecting circuitry 202 (a CPU 20/GPU 30, for example) may select one or more virtual elements for the estuary and plains based on the environment geometry data provided.

The selecting model may be any suitable machine learning model/neural network and may be trained using image data of real-world environments (real-world cities, for example), and/or (image data) of other 3D virtual environments (virtual cities from other video games, for example).

The selecting model may be trained to select virtual elements based on the geometric/topological features present within the environment geometry data. For example, the selecting model may detect the river bed and banks, as well as flat plains of land within the provided environment geometry data, and select virtual elements such as skyscrapers, urban infrastructure, and the like, based on these detected geometric features; owing to its training, the selecting model may correlate wide river estuaries and plains with the presence of large cities (real-world examples including London, Rotterdam, Antwerp, and the like).

The selecting model may select these virtual elements from one or more asset libraries/databases. A given virtual element may be a generic one that is purchasable from an asset library/database, or one that has been made bespoke for the video game that is being developed by the game developer.

In any case, once the virtual elements have been selected by the selecting model, generating circuitry 204 (a CPU 20/GPU 30, for example) may instantiate the selected virtual elements within the virtual river estuary and plains, and thereby create the large city.

Thus, the creative burden placed on the game developer may be reduced to modifying the locations/orientations of the instantiated elements (if deemed necessary by the developer), or even reduced to providing the environment geometry data to the content generation system (if the selecting model is also optionally trained to determine the appropriate locations/orientations in which selected virtual elements are to be instantiated). Because of this, the time taken to develop the video game is reduced.

### Receiving Circuitry 200

In embodiments of the present description, receiving circuitry 200 is configured to receive environment geometry data of at least part of a three-dimensional, 3D, virtual environment.

Where the environment geometry data is received from outside of the content generation system (such as from a different computer, a different games consoles, or the like), receiving circuitry 200 may comprise one or more data ports, such as data port 60, USB ports, Ethernet® ports, Wi-Fi® ports, Bluetooth® ports, or the like.

Alternatively or in addition, where the environment geometry data is received from within the content generation system (such as from a HDD, SSD 50, RAM 40, or the like), receiving circuitry 200 may comprise an I/O bus such as bus 100.

The environment geometry data may define the geometry of the at least part of the 3D virtual environment. For example, the environment geometry data may comprise a mesh, a point cloud, or the like, of the at least part of the 3D virtual environment.

Optionally, the environment geometry data may have texture data associated therewith, and the texture data may comprise one or more textures to be applied to the at least part of the 3D virtual environment. Optionally, the texture data may indicate which portion of the environment geometry data a given texture is to be applied.

Turning back to the large city example, the environment geometry data may have a sand/silt texture and a grass/earth texture associated therewith, and the sand/silt texture may be applied to the portion of the environment geometry data that represents the riverbed and banks, whereas the grass/earth texture may be applied to the portion of the environment geometry data that represents the surrounding plains.

As will be appreciated by persons skilled in the art, this associated texture data may be used by the selecting model to select virtual elements for the at least part of the 3D virtual environment.

Turning to the large city example, the selecting model may select the skyscrapers, urban infrastructure, and the like, based on the large shape/size of the flat plains relative to that of the riverbed, as well as the grass/earth texture to be applied to the plains.

Alternatively, the selecting model may select trees, vegetation, wild animals, and the like, may be selected by the selecting model in the case where the terrain surrounding the river bed does not represent flat plains, but instead represents a rocky/hilly terrain (the geometry is more discontinuous/undulating, and rocky and grass/earth textures are applied thereto) which is less accommodating to large urban areas than wild flora and fauna.

Texture-based selection of virtual elements shall be discussed later herein.

Alternatively or in addition, the environment geometry data may optionally have environment metadata associated therewith. The environment metadata may comprise at least one of:
an indication of a type and/or genre of content for which the environment geometry data has been generated (types of content may include an animated film, a video game, and the like, and genre of content may include fantasy, horror, sports, war/military, and the like), and
an indication of a type of environment the environment geometry data represents (types of environments may include arctic tundra, desert, mountains, hills, valleys, urban areas, rural areas, and the like).

As will be appreciated by persons skilled in the art, this associated environment metadata may be used by the selecting model to select virtual elements for the at least part of the 3D virtual environment.

Turning to the large city example, the selecting model may select the skyscrapers, urban infrastructure, and the like, based on the large shape/size of the flat plains relative to that of the riverbed, as well as the associated environment metadata indicating that the environment geometry data represents an urban area.

Metadata-based selection of virtual elements shall be discussed later herein.

Alternatively or in addition, receiving circuitry 200 may be configured to optionally receive input data indicative of a user prompt, that is, a user's desired outcome vis-à-vis which (and/or how the) virtual elements are to populate (that is, be instantiated within) the 3D virtual environment.

The user prompt may be a text prompt or voice prompt. For example, the user may speak or write a statement such as “this part of the environment is a capital city”, which may be used by the selecting model to select virtual elements such skyscrapers, urban infrastructure, and the like, for the at least part of the 3D virtual environment.

Alternatively, the user prompt may be a gestural prompt. For example, content generation system may comprise an imaging device operable to capture images of the user, and the captured image data may depict the user moving their hand along an “S” shape path, which may indicate that the selected virtual elements are to be instantiated in a generally “S” shape configuration on the flat plain. The content generation system may comprise object recognition circuitry configured to detect objects (such as the user's hand) in the captured image data, and the “S” shape path may be detected by the object recognition circuitry, for example.

Prompt-based selection of virtual elements shall be discussed later herein.

In any case, the environment geometry data (any of the other types of data mentioned above) may be received by receiving circuitry 200, and the selection of virtual elements to be instantiated within the at least part of the 3D virtual environment of the environment geometry data may be carried out by the selecting model based on the received data.

### Selecting Circuitry 202

In embodiments of the present description, selecting circuitry 202 comprises a selecting model that is trained select, based on the received environment geometry data, one or more virtual elements. In embodiments of the present description, the selecting model may be any suitable machine learning model/neural network executed by the selecting circuitry 202, which may be one or more CPUs 20 and/or one or more GPUs 30, for example.

As mentioned previously, a given virtual element may be:
a virtual character (a user-controllable character or a non-player character, for example, which may be a human, animal, alien, zombie, monster, or the like);
a virtual object (a building, a vehicle, an item of furniture, cutlery, crockery, a weapon, or the like); and
a texture (that represents a pattern, a colour, a wallpaper, surface decoration, wood grain, brickwork, rusted metal, or the like, to be applied to some of the 3D virtual environment or to a selected virtual character/object).

It should be noted that the preceding example are not exhaustive; the skilled person will appreciate that virtual elements other than those mentioned in the above list fall within the scope of the present description.

As mentioned previously, the environment geometry data defines the surface geometry of at least part of the 3D virtual environment. As such the selecting model may be trained to select virtual elements based on one or more geometric/topological features present in the surface geometry of the of at least part of the 3D virtual environment (that is, present within the environment geometry data).

As a non-limiting example, the selecting model may firstly identify one or more geometric/topological features by taking the gradient and/or curvature (that is, the first and/or second derivative, respectively) of the 3D virtual environment's surface geometry into account. It will be appreciated further derivatives may be used, as appropriate.

Turning back to the large city example, the selecting model may detect the riverbed and banks as being distinct from the surrounding plains by detecting where the gradient and/or curvature of the 3D virtual environment's surface geometry changes from zero to a non-zero value, for example, as depicted in FIG. 3.

FIG. 3 depicts a cross section through the environment geometry data of the river estuary and plains. The selecting model may detect five geometric topological features in the environment geometry data based on the gradient and/or curvature of the environment geometry data. For example, features 1 and 5 are detected as being distinct from features 2 and 4, respectively, and the location in the environment geometry data at which the gradient changes between zero to a non-zero value demarcates the different features (represented by the dashed lines between features 1 and 2, and features 4 and 5). Feature 3 may be detected as being distinct from features 2 and 4 at the locations at which the gradient is zero, and the curvature is less than zero (represented by the dashed lines between features 2 and 3 and features 3 and 4).

Once the geometric/topological features have been detected, the selecting model may subsequently associate each feature with a geographical/environmental feature (such as mountains, hills, valleys, rivers beds, plains, and the like). The selecting model may do so by considering the relative sizes, shapes, gradients and/or curvatures of the detected geometric/topological features with respect to each other.

Turning back to the example of FIG. 3, feature 3 may be identified as a riverbed (as opposed to a valley) because of the difference in height between the lowest point of the riverbed and the plain. That is to say that the selecting model may determine that this height difference is too small for feature 3 to be a valley but is rather a riverbed. Thus, the selecting model associates feature 3 with a riverbed. The selecting model may associate features 2 and 4 with riverbanks (as opposed to foothills) in a similar manner. The selecting model may associate features 1 and 5 with plains because of the flat shapes (and optionally zero gradient and/or curvature) thereof.

Once the geographical/environmental features have been associated with the geometric/topological features, the selecting model may select one or more virtual elements based on the geographical/environmental features. For example, the selecting model may select the skyscrapers, urban infrastructure, and the like, based on there being plains, riverbanks and a riverbed present within the environment geometry data.

Optionally, the selection may be based on the relative sizes/shapes of these geographical/environmental features. For example, the plains may cover a larger area compared to the river bed, and so more buildings and urban infrastructure virtual elements should be selected, rather than rural/wilderness virtual elements; owing to its training, the selecting model may find that large cities are more likely to be built in large plains surrounding a river, and villages/settlements more likely to be built in small plains (or even hilly terrain) surrounding a river, for example.

Where the environment geometry data has texture data associated therewith, the selecting model may be trained to select one or more of the virtual elements based on the texture data (as well as the environment geometry data).

Turning back to the large city example, the texture data may comprise a grass/earth texture to be applied to portions of the environment geometry data that represent the plains surrounding the river. The selecting model may subsequently select skyscrapers, urban infrastructure, and the like, based on the grass/earth texture being present (as opposed to an icy glacier texture being present, for example).

In addition, the selection may be based on the relative sizes/shapes of and/or the geographical/environmental features associated with the portions of the 3D virtual environment to which a given texture is to be applied. For example, the portions of the 3D virtual environment to which the grass/earth texture is to be applied may cover a larger area compared to the portion to which a sand/silt texture is to be applied, and so more buildings, urban infrastructure and other land-based virtual elements should be selected, rather than rural/wilderness virtual elements. Alternatively or in addition, the portions of the 3D virtual environment to which the grass/earth texture is to be applied may have been associated with the geographical/environmental feature of a plain.

Alternatively or in addition, where the environment geometry data has environment metadata associated therewith, the selecting model may be trained to select one or more of the virtual elements based on the environment metadata (as well as the environment geometry data).

Turning back to the large city example, the environment metadata may indicate that the environment geometry data represents an urban area and/or that the environment geometry data is intended for a racing video game. The selecting model may subsequently select skyscrapers, urban infrastructure, and the like, based on the indication, provided by the environment metadata, that the environment geometry data represents an urban area (as opposed to an arctic tundra) and/or that the environment geometry data is for a racing video game (rather than a high fantasy game).

In addition, the selection may be based on the (relative shapes/sizes of the) geographical/environmental features associated with the at least part of the 3D virtual environment, as discussed previously.

Alternatively or in addition, where receiving circuitry 200 is configured to receive input data, the selecting model may be trained to select one or more of the virtual elements based on the received input data (as well as the environment geometry data).

Turning back to the large city example, the game developer may provide input data corresponding to a text prompt such as “this part of the environment is a capital city”. The selecting model may perform a semantic analysis on the text prompt, and may subsequently select skyscrapers, urban infrastructure, and the like, based on the results of the semantic analysis of the text prompt.

In addition, the selection may be based on the (relative shapes/sizes of the) geographical/environmental features associated with the at least part of the 3D virtual environment, as discussed previously.

In any case, in order to prevent the selecting model from selecting at least one of every (or at least one of each of a majority of the) virtual element(s) stored in an asset library/database in the hope that at least some of the selected virtual elements are appropriate for the 3D virtual environment, the selecting model may be constrained to select less than or equal to a predetermined number of virtual elements.

The selecting model may be trained using one or more sets of image data of one or more real-world environments. A given set of image data may be a single (still) image or may be a sequence of two or more image frames depicting a moving image, for example. Each set of image data may depict a respective one or more real-world environments (a moving image may encompass, a scene change from one real-world environment to another, for example). Examples of real-world environments include cities, countryside, deserts, coastline, arctic tundra, sports stadiums, cathedrals, concert halls, restaurants, pubs, houses, bedrooms, kitchens, and the like.

For each set of image data, the selecting model may be trained to correlate the real-world objects (whether animate or inanimate) depicted in the set with the real-world environment depicted in the set.

For example, a given set of image data may depict a background of rolling hills some of which being covered in woodland/forest, and a foreground comprising a fox chasing a squirrel. This set of image data may be analysed by selecting circuitry 200 or different processing circuitry (optionally, of a different computing system) using computer vision in order to identify the fox, squirrel, trees and hills, for example.

The terms “computer vision algorithm” and “object recognition algorithm” refer to any suitable computer-implemented method, software, algorithm, or the like, which causes a computer (such as the apparatus described herein) to recognise/detect objects, animals, humans, or the like from captured images. Such algorithms are well-known in the art, examples of which include Viola-Jones detection methods (optionally based on Haar features), scale-invariant feature transforms (SIFTs), histogram of oriented gradients (HOG) features, and the like. Alternatively or in addition, machine learning and methods, neural networks, artificial intelligence, or the like may be used to recognise/detect objects and the like. Examples of neural network approaches include region based convolutional neural networks (R-CNNs), single shot multi-box detectors (SSDs), you only look once (YOLO) methods, single-shot refinement neural networks for object detection (RefineDets), Retina-Net, deformable convolutional networks, and the like.

Optionally, one or more of the sets of image data may have object metadata respectively associated therewith, wherein the object metadata associated with a given set of image data comprises an indication of one or more animate objects and/or one or more inanimate objects depicted in the set of image data. For example, if a given set of image data is retrieved from a social media website/application, then the set of image data may have so-called “hashtags” associated therewith, where each hashtag may identify an object in the set of image data (“#squirrels #woodland”, for example). These hashtags may aid in the identification of objects in the set of image data, as the hashtag may serve as a priori knowledge of there being one or more squirrels and one or more trees depicted in the set of image data.

In any case, after the set of image data is analysed, the hills may be tagged (by a human or a classifying model comprised within selecting circuitry 200) as a geographical/environmental feature, and the trees, fox and squirrel may be tagged as (animate) objects. The tagged set of image data may then be input to the selecting model.

The selecting model may learn the typical geometry/topology of hills by taking into account the shape/size of the hills in the set of image data. This learning may enable the selecting model to determine whether a geometric/topological feature comprised within environment geometry data input thereto during operation corresponds to the geographical/environmental feature of a hill.

The selecting model may also learn a correlation between a hilly environment and the presence of trees, foxes and squirrels therein. This learning may enable the selecting model, during operation, to select trees, foxes and squirrels for instantiation within the 3D virtual environment represented by the environment geometry data input to the selecting model.

Alternatively or in addition, the selecting model may be trained using one or more other 3D virtual environments (from other video games, films, or the like, for example) respectively comprising one or more virtual elements instantiated therein.

For example, a set of one or more rendered images (that is, a set of image data) of a given other 3D virtual environment may be input to the selecting model in order to train the selecting model in a similar manner to that discussed with respect to using sets of image data of real-world environments.

Alternatively, both the environment geometry data of the other 3D virtual environment and the set of virtual elements instantiated therein may be input to the selecting model. That is to say that rather than using two-dimensional images of the 3D virtual environment and virtual elements, the surface geometry of 3D virtual environment and the 3D virtual elements may be used to train the selecting model.

The selecting model may thus learn a correlation between the geometry/topology of the other 3D virtual environments and the virtual elements respectively instantiated therein. This learning may thus enable the selecting model, during operation, to select virtual elements based on the geometric/topological features comprised within the inputted environment geometry data without having to attribute geographical/environment features to the geometric/topological features, for example.

Optionally, one or more of the other 3D virtual environments may have respective texture data and/or environment metadata associated therewith.

The selecting model may thus learn correlations between the geometry/topology of the other 3D virtual environments and the types of environments being respectively represented by the other 3D virtual environments. This learning may enable the selecting model, during operation, to associate geographical/environment features with geometric/topological features comprised within the inputted environment geometry data. Alternatively or in addition, the selecting model may learn other correlations such as those between genre of content and virtual elements (monsters may be correlated with horror games/animated films, for example), and those between textures to be applied to the 3D virtual element and virtual elements (urban infrastructure may be correlated more strongly with grass/earth textures than say icy glacier textures, for example).

In any case, the selecting model is trained to select one or more virtual elements to be instantiated by generating circuitry 204 within the 3D virtual environment based on at least the environment geometry data of that 3D virtual environment (and optionally any datasets associated with the environment geometry data such as texture data, metadata, user prompts, and the like).

### Instantiating Virtual Elements

In embodiments of the present description, generating circuitry 204 is configured to instantiate the selected virtual elements within the at least part of the virtual environment. In embodiments of the present description, generating circuitry 204 may be one or more CPUs 20 and/or one or more GPUs 30, for example.

As will be appreciated by persons skilled in the art, the term “instantiate” and derivatives/declensions thereof refer to the importation of the selected virtual elements into the 3D virtual environment defined by the environment geometry data. That is to say that, once selected by the selecting model, generating circuitry 204 imports the virtual elements into the 3D virtual environment such that whenever the at least part of the 3D virtual environment is rendered for display, the selected virtual elements are also rendered as being a part of (or otherwise situated within) the 3D virtual environment.

Hence, it will be appreciated that embodiments of the present description may comprise rendering circuitry configured to render, for display, the at least part of the 3D virtual environment having the selected virtual elements instantiated therein.

Optionally, receiving circuitry 200 may be configured to receive one or more control signals for performing one or more changes to the instantiated virtual elements; and generating circuitry 204 may be configured to perform the one or more changes to the instantiated virtual elements based on the received control signals.

That is to say that the instantiation of the selected virtual elements with the virtual environment need not be immutable, but rather subject to any further changes that a user (such as a game/film developer) may wish to carry out in order to obtain the desired (layout of the) set of virtual elements for the 3D virtual element.

As will be appreciated by persons skilled in the art, a given change to the instantiated virtual elements carried out by generating circuitry 204 in response to one or more of the control signals received at receiving circuitry 200 may be one of:
instantiation, within the 3D virtual environment, an additionally selected virtual element (that is, a virtual element which was not selected by the selecting model);
removing, from the 3D virtual environment, an instantiated virtual element (that is, a virtual element which was selected by the selecting model);
substituting an instantiated virtual element for an additionally selected virtual element (that is, swapping a virtual element which was selected by the selecting model for one which was not selected by the selecting model);
changing a location at which an instantiated (or additionally selected) virtual element is currently instantiated;
changing an orientation in which an instantiated (or additionally selected) virtual element is currently instantiated; and
changing an appearance of an instantiated (or additionally selected) virtual element (that is, changing the size, shape, colour, and the like, of the virtual element in question).

It should be noted that the preceding example are not exhaustive; the skilled person will appreciate that virtual elements other than those mentioned in the above list fall within the scope of the present description.

The control signals received at receiving circuitry 200 may be received from one or more of:
a user input device (a game controller, mouse, keyboard, mobile phone, or the like);
a camera (standalone or comprised within a computer, mobile phone, head mounted display, TV, user input device, or the like); and
a microphone (standalone or comprised within a computer, mobile phone, head mounted display, TV, user input device, or the like).

It should be noted that the preceding examples are not exhaustive; persons skilled in the art will appreciate that types of devices operable to transmit user inputs to receiving circuitry 200 other than those mentioned in the above list are considered within the scope of the present description.

Further optionally, the selecting model may be trained using one or more of the changes performed by generating circuitry 204. That is to say that the changes made by the user may be used as feedback in order to further train the selecting model to select virtual elements that are more appropriate to the 3D virtual environments received at receiving circuitry 200 in future.

Turning to the large city example, the selecting model may select a cottage as one of the virtual elements to be instantiated in the 3D virtual environment. A user of the content generation system may subsequently wish to remove the cottage from the virtual environment because they feel that it is not in keeping with the urban setting intended for this 3D virtual environment. Therefore, the user may provide control signals to receiving circuitry 200, and, based thereon, generating circuitry 204 may subsequently remove the cottage from the 3D virtual environment. Information regarding the removal of the cottage from the 3D virtual environment may be sent to the selecting model so that the selecting model may be trained to refrain from selecting cottages for urban environments in future.

As will be appreciated by persons skilled in the art, the changes used to train the selecting model are preferably ones that will enable a better (that is, more appropriate) selection of virtual elements, rather than enable a better (that is, more appropriate) instantiation (in terms of virtual environment locations and/or virtual element orientations/appearances) of selected virtual elements.

Embodiments of the present description may comprise modifying circuitry 206, which may comprise a modifying model trained to modify, based on the received environment geometry data, one or more of the selected virtual elements. In such embodiments, modifying circuitry 206 may be one or more CPUs 20 and/or one or more GPUs 30, for example. Accordingly, generating circuitry 204 may be configured to instantiate the modified virtual elements within the at least part of the virtual environment.

That is to say that once the virtual elements have been selected by the selecting model, the modifying model may modify the appearance (the size, shape, colour, and the like) of the selected virtual elements prior to instantiation within the 3D virtual environment by generating circuitry 204. Turning to the large city example, the selecting model may select a skyscraper virtual element for the 3D virtual environment, and the modifying model may subsequently modify the shape of the skyscraper such that it is made taller than it originally was. Generating circuitry 204 may subsequently instantiate the taller skyscraper within the 3D virtual environment.

Alternatively or in addition, embodiments of the present description may comprise determining circuitry 208, which may comprise a determining model trained to determine, based on the received environment geometry data, a location within the at least part of the virtual environment for a given selected virtual element and/or an orientation for the given selected virtual element. In such embodiments, determining circuitry 208 may be one or more CPUs 20 and/or one or more GPUs 30, for example. Accordingly, generating circuitry 204 may be configured to instantiate the given selected virtual element within the at least part of the virtual environment at the determined location and/or in the determined orientation.

That is to say that once the virtual elements have been selected by the selecting model, the determining model may determine appropriate locations and/or orientations within the 3D virtual environment for the selected virtual elements. Turning back to the large city example, the selecting model may select a cathedral, and the determining model may determine that the large cathedral should be oriented such that the façade thereof (housing the main doors into the cathedral) points due west (as is commonly the case in real-world cathedrals) and/or that the cathedral be located near one of the banks of the river (and thus centrally located within a large city that is built along both sides of the river, for example).

As will be appreciated by persons skilled in the art, the modifying model and/or the determining model may be trained in any of the aforementioned ways in which selecting model may be trained. That is to say that the training of the selecting model may be used, mutatis mutandis, to train the modifying model and/or the determining model.

Alternatively or in addition, the modifying model and/or the determining model may be trained using dedicated training datasets.

For example, the modifying model may be trained using a dataset that indicates the average dimensions, shapes, colours, and the like, of types of real-world objects. For example, a dataset for training the modifying model may include rules of thumb regarding the typical heights, shapes and colours of skyscrapers, such as skyscraper typically being greater than or equal to 150 metres tall, cuboidal in shape, and grey in colour (due to use of concrete).

As another example, the determining model may be trained using a dataset that indicates the typical locations and/or orientations of types of real-world objects. For example, a dataset for training the determining model may include rules of thumb such as cathedrals typically being centrally located within large cities (for easy access thereto by the city's population) and the façade typically facing due west (so that the ambulatory and choir of the cathedral point due east, towards the rising sun).

In any case, embodiments of the present description seek to reduce the amount of time taken to develop games/animated films and/or creative burden imposed on game/film developers by providing an automatic selection and instantiation of virtual elements that are appropriate to the virtual environment of the game/film under development.

### Content Generation Method

Turning now to FIG. 4, a content generation method comprises the following steps:
S100: receiving environment geometry data of at least part of a three-dimensional, 3D, virtual environment, as described elsewhere herein.
S102: selecting, using a trained selecting model, one or more virtual elements based on the received environment geometry data, as described elsewhere herein.
S104: instantiating the selected virtual elements within the at least part of the virtual environment, as described elsewhere herein.

Example(s) of the present technique are defined by the following numbered clauses:
1. A content generation system, comprising:
   receiving circuitry configured to receive environment geometry data of at least part of a three-dimensional, 3D, virtual environment;
   selecting circuitry comprising a selecting model trained to select, based on the received environment geometry data, one or more virtual elements; and
   generating circuitry configured to instantiate the selected virtual elements within the at least part of the virtual environment.
2. A content generation system according to clause 1, wherein:
   the environment geometry data has texture data associated therewith, the texture data comprising one or more textures to be applied to the at least part of the 3D virtual environment; and
   the selecting model is trained to select, based on the texture data, one or more of the virtual elements.
3. A content generation system according to clause 1 or clause 2, wherein:
   the environment geometry data has environment metadata associated therewith, the environment metadata comprising at least one of:
i. an indication of a type and/or genre of content for which the environment geometry data has been generated, and
ii. an indication of a type of environment the environment geometry data represents; and
   the selecting model is trained to select, based on the environment metadata, one or more of the virtual elements.
4. A content generation system according to any preceding clause, wherein the selecting model is constrained to select less than or equal to a predetermined number of virtual elements.
5. A content generation system according to any preceding clause, wherein:
   the receiving circuitry is configured to receive input data indicative of a user prompt; and
   the selecting model is trained to select one or more of the virtual elements based on the received input data.
6. A content generation system according to any preceding clause, wherein the selecting model is trained using one or more sets of image data of one or more real-world environments.
7. A content generation system according to any preceding clause, wherein the selecting model is trained using one or more other 3D virtual environments respectively comprising one or more virtual elements instantiated therein.
8. A content generation system according to any preceding clause, wherein:
   the receiving circuitry is configured to receive one or more control signals for performing one or more changes to the instantiated virtual elements; and
   the generating circuitry is configured to perform the one or more changes to the instantiated virtual elements based on the received control signals.
9. A content generation system according to clause 8, wherein the selecting model is trained using one or more of the changes performed by the generating circuitry.
10. A content generation system according to any preceding clause, comprising:
   modifying circuitry comprising a modifying model trained to modify, based on the received environment geometry data, one or more of the selected virtual elements;
   wherein the generating circuitry is configured to instantiate the modified virtual elements within the at least part of the virtual environment.
11. A content generation system according to any preceding clause, comprising:
   determining circuitry comprising a determining model trained to determine, based on the received environment geometry data, a location within the at least part of the virtual environment for a given selected virtual element and/or an orientation for the given selected virtual element;
   wherein the generating circuitry is configured to instantiate the given selected virtual element within the at least part of the virtual environment at the determined location and/or in the determined orientation.
12. A content generation system according to any preceding clause, wherein a given virtual element is one of:
   i. a virtual character;
   ii. a virtual object; and
   iii. a texture.
13. A content generation method, comprising the steps of:
   receiving environment geometry data of at least part of a three-dimensional, 3D, virtual environment;
   selecting, using a trained selecting model, one or more virtual elements based on the received environment geometry data; and
   instantiating the selected virtual elements within the at least part of the virtual environment.
14. A computer program comprising computer executable instructions adapted to cause a computer system to perform the method of clause 13.
15. A non-transitory, computer-readable storage medium having stored thereon the computer program of clause 14.

It will be apparent to a person skilled in the art that variations in the above method corresponding to operation of the various embodiments of the apparatus as described and claimed herein are considered within the scope of the present invention.

It will be appreciated that the above methods may be carried out on conventional hardware (such as entertainment device 10) suitably adapted as applicable by software instruction or by the inclusion or substitution of dedicated hardware.

Thus the required adaptation to existing parts of a conventional equivalent device may be implemented in the form of a computer program product comprising processor implementable instructions stored on a non-transitory machine-readable medium such as a floppy disk, optical disk, hard disk, solid state disk, PROM, RAM, flash memory or any combination of these or other storage media, or realised in hardware as an ASIC (application specific integrated circuit) or an FPGA (field programmable gate array) or other configurable circuit suitable to use in adapting the conventional equivalent device. Separately, such a computer program may be transmitted via data signals on a network such as an Ethernet, a wireless network, the Internet, or any combination of these or other networks.

The foregoing discussion discloses and describes merely exemplary embodiments of the present invention. As will be understood by those skilled in the art, the present invention may be embodied in other specific forms without departing from the spirit or essential characteristics thereof. Accordingly, the disclosure of the present invention is intended to be illustrative, but not limiting of the scope of the invention, as well as other claims. The disclosure, including any readily discernible variants of the teachings herein, defines, in part, the scope of the foregoing claim terminology such that no inventive subject matter is dedicated to the public.

1. A content generation system, comprising:
receiving circuitry configured to receive environment geometry data of at least part of a three-dimensional, 3D, virtual environment;
selecting circuitry comprising a selecting model trained to select, based on the received environment geometry data, one or more virtual elements; and
generating circuitry configured to instantiate the selected virtual elements within the at least part of the virtual environment.

2. A content generation system according to claim 1, wherein:
the environment geometry data has texture data associated therewith, the texture data comprising one or more textures to be applied to the at least part of the 3D virtual environment; and
the selecting model is trained to select, based on the texture data, one or more of the virtual elements.

3. A content generation system according to claim 1, wherein:
the environment geometry data has environment metadata associated therewith, the environment metadata comprising at least one of:
i. an indication of a type and/or genre of content for which the environment geometry data has been generated, and
ii. an indication of a type of environment the environment geometry data represents; and
the selecting model is trained to select, based on the environment metadata, one or more of the virtual elements.

4. A content generation system according to claim 1, wherein the selecting model is constrained to select less than or equal to a predetermined number of virtual elements.

5. A content generation system according to claim 1, wherein:
the receiving circuitry is configured to receive input data indicative of a user prompt; and
the selecting model is trained to select one or more of the virtual elements based on the received input data.

6. A content generation system according to claim 1, wherein the selecting model is trained using one or more sets of image data of one or more real-world environments.

7. A content generation system according to claim 1, wherein the selecting model is trained using one or more other 3D virtual environments respectively comprising one or more virtual elements instantiated therein.

8. A content generation system according to claim 1, wherein:
the receiving circuitry is configured to receive one or more control signals for performing one or more changes to the instantiated virtual elements; and
the generating circuitry is configured to perform the one or more changes to the instantiated virtual elements based on the received control signals.

9. A content generation system according to claim 8, wherein the selecting model is trained using one or more of the changes performed by the generating circuitry.

10. A content generation system according to claim 1, comprising:
modifying circuitry comprising a modifying model trained to modify, based on the received environment geometry data, one or more of the selected virtual elements;
wherein the generating circuitry is configured to instantiate the modified virtual elements within the at least part of the virtual environment.

11. A content generation system according to claim 1, comprising:
determining circuitry comprising a determining model trained to determine, based on the received environment geometry data, a location within the at least part of the virtual environment for a given selected virtual element and/or an orientation for the given selected virtual element;
wherein the generating circuitry is configured to instantiate the given selected virtual element within the at least part of the virtual environment at the determined location and/or in the determined orientation.

12. A content generation system according to claim 1, wherein a given virtual element is one of:
i. a virtual character;
ii. a virtual object; and
iii. a texture.

13. A content generation method, comprising the steps of:
receiving environment geometry data of at least part of a three-dimensional, 3D, virtual environment;
selecting, using a trained selecting model, one or more virtual elements based on the received environment geometry data; and
instantiating the selected virtual elements within the at least part of the virtual environment.

14. A content generation method according to claim 13, wherein:
the environment geometry data has texture data associated therewith, the texture data comprising one or more textures to be applied to the at least part of the 3D virtual environment; and
the selecting model is trained to select, based on the texture data, one or more of the virtual elements.

15. A content generation method according to claim 13, wherein:
the environment geometry data has environment metadata associated therewith, the environment metadata comprising at least one of:
i. an indication of a type and/or genre of content for which the environment geometry data has been generated, and
ii. an indication of a type of environment the environment geometry data represents; and
the selecting model is trained to select, based on the environment metadata, one or more of the virtual elements.

16. A content generation method according to claim 13, wherein:
the receiving circuitry is configured to receive input data indicative of a user prompt; and
the selecting model is trained to select one or more of the virtual elements based on the received input data.

17. A non-transitory, computer-readable storage medium having stored thereon computer executable instructions to control a computer to:
receive environment geometry data of at least part of a three-dimensional, 3D, virtual environment;
select, using a trained selecting model, one or more virtual elements based on the received environment geometry data; and
instantiate the selected virtual elements within the at least part of the virtual environment.

18. A non-transitory, computer-readable storage medium according to claim 17, wherein:
the environment geometry data has texture data associated therewith, the texture data comprising one or more textures to be applied to the at least part of the 3D virtual environment; and
the selecting model is trained to select, based on the texture data, one or more of the virtual elements.

19. A non-transitory, computer-readable storage medium according to claim 17, wherein:
the environment geometry data has environment metadata associated therewith, the environment metadata comprising at least one of:
i. an indication of a type and/or genre of content for which the environment geometry data has been generated, and
ii. an indication of a type of environment the environment geometry data represents; and
the selecting model is trained to select, based on the environment metadata, one or more of the virtual elements.

20. A non-transitory, computer-readable storage medium according to claim 17, wherein:
the receiving circuitry is configured to receive input data indicative of a user prompt; and
the selecting model is trained to select one or more of the virtual elements based on the received input data.
